(19) United States
(12) Patent Application Publication
(10) Pub. No.: US 2018/0247269 A1
(43) Pub. Date: Aug. 30, 2018

(54) ELECTRONIC BUSINESS CARD SYSTEM AND METHOD FOR PROVIDING CONTACT INFORMATION

(71) Applicant: Kim L. Lumley, New Castle, CO (US)

(72) Inventor: Kim L. Lumley, New Castle, CO (US)

(21) Appl. No.: 15/756,452

(22) PCT Filed: Aug. 29, 2016
(86) PCT No.: PCT/US16/49268

§ 371 Date: Feb. 28, 2018

Related U.S. Application Data
(60) Provisional application No. 62/211,073, filed on Aug. 28, 2015.

(51) Int. Cl. G06Q 10/10; G06Q 30/06

(52) U.S. Cl. CPC G06Q 10/109; G06K 19/06187; G06Q 30/0609

(57) ABSTRACT

A business card system and a method for providing contact information to a user. The system includes a database server storing a plurality of contact user data records, the contact user data records each including contact user information such as a contact name, a contact physical address, a contact telephone number, a contact facsimile number and a contact email address, where each contact user data record is associated with one of a plurality of system contact users. A contact user identification card is associated with each system contact user and includes a code that is associated with the contact user data record in the database. An input device and an electronic communication device receive and transmit the code to the database server and receives the contact user information from the server. The contact user data records do not include contact user payment data.

### CROSS-REFERENCE TO RELATED APPLICATION

This application claims the priority benefit of U.S. Provisional Application No. 62/211,073 filed on Aug. 28, 2015, which is incorporated herein by reference in its entirety.

### FIELD

This disclosure relates to the field of systems and methods for efficiently facilitating to the transfer of contact information relating to an individual and/or an entity, such as to complete a transaction between a buyer and a seller of goods or services.

### SUMMARY

In one embodiment of the present disclosure, a business card system is described. The business card system comprises a database server comprising a database, the database comprising a plurality of contact user data records, the contact user data records each comprising at least two pieces of contact user information selected from a contact name, a contact physical address, a contact telephone number, a contact facsimile number and a contact email address, where each contact user data record is associated with one of a plurality of system contact users. A contact user identification card is associated with each system contact user, the contact user identification card comprising contact user identification code that is associated with the contact user data record that is stored in the database. At least one input device is configured to receive the contact user identification code from the contact user identification card, and an electronic communication device is operatively associated with the input device to receive the contact user identification code through the input device. The electronic communication device is in operative communication with the database server to transmit the contact user identification code to the database server and to receive the at least two pieces of contact user information from the database server. Advantageously, the contact user data records do not include contact user payment data.

The foregoing embodiment of a business card system is subject to a number of characterizations and arrangements, alone or in any combination. Thus, in one characterization, the contact user data records each comprise at least a contact name, a contact physical address and a contact telephone number. In this characterization, the contact name may be selected from an individual contact name, an entity contact name (e.g., a corporate entity) or both an individual contact name and an entity contact name. In a further characterization, the contact physical address may be selected from a billing address, a shipping address or both a billing address and a shipping address. In another characterization, the contact user data records may include an email address, e.g., an email address that is associated with the contact.

In one arrangement of this business card system, the user identification data is stored in a magnetic strip on the contact user identification card, and in this arrangement the input device may include magnetic strip reader, e.g., that is configured to read the contact user identification card. In another arrangement, the user identification data may be stored in a scannable one-dimensional bar code, and/or in a scannable two-dimensional bar code such as where the two-dimensional bar code is a Quick Response Code (QR Code). Accordingly, the input device may include a bar code scanner, e.g., that is configured to read the bar code on the contact user identification card.

In another arrangement, the user identification data comprises alphanumeric text (e.g., letters and/or numbers) that are uniquely associated with a system contact user. In this arrangement, the input device may include an alphanumeric keypad, e.g., for manual input of the alphanumeric text.

In one characterization of this system, the electronic communication device is operatively associated with the input device through a wireless connection, such as a wireless network (e.g., a wireless LAN network). The electronic communication device may also be configured to be in operative communication with the database server through a wide area network (WAN). In another characterization, the electronic communication device may be in operative communication with the database server through a cellular telephone network, e.g., a CDMA or GSM network.

In certain arrangements, input device and the electronic communication device comprise a single device, such as a smartphone or another computing device having a processor, memory and a display screen, such as a personal computer or a tablet.

In another arrangement, the contact user input device is configured to enable access to the database server to enable the contact user to edit the contact user's own data record, e.g., by providing access credentials such as a password. The contact user's access to the database server may be limited such that the contact user cannot manipulate another contact user's information stored in the database.

In another arrangement, the contact user identification card is a plastic (e.g., polymeric) card comprising alphanumeric text representing at least a portion of the contact user information. In another arrangement, the contact user identification card is a paper (e.g., cellulosic) card comprising alphanumeric text representing at least a portion of the contact user information. In one characterization, the paper contact user identification card comprises a scannable bar code comprising the contact user identification code, as is disclosed above.

In another embodiment, a method for providing contact user information to a contact information recipient is provided. The method includes receiving, from a contact user, at least two pieces of contact user information selected from a contact name, a contact physical address, a contact telephone number, a contact facsimile number and a contact email address. A contact user data record is created that includes the at least two pieces of contact user information, the contact user data record is associated with the contact user, and a contact user identification code is created for the contact user. The method also includes receiving, from a contact information recipient, a request for at least a portion of the contact user information, where the request includes the contact user identification code. The contact information recipient is provided with the requested portion of the contact user information, e.g., upon confirmation of the identification code. The contact user data record does not include contact user payment data.

The foregoing embodiment of a method for providing contact user information is subject to a number of characterizations and arrangements, which may be implemented alone or in any combination. Thus, in one characterization, the contact user data records each include at least a contact name, a contact physical address and a contact telephone number. In one arrangement, the contact name is selected from an individual contact name, an entity contact name (e.g., corporate entity), or both an individual contact name and an entity contact name. The contact physical address may be selected from a billing address, a shipping address, or both a billing address and a shipping address. In another arrangement, the contact user data records include an email address.

In one characterization, the user identification data is provided by the contact user to the contact information recipient. In this regard, the user identification data may be stored in a magnetic strip on a contact user identification card. Alternatively, or in addition, the user identification data may be stored in a scannable one-dimensional bar code or in a scannable two-dimensional bar code, such as in a QR Code. Alternatively, or in addition to, the user identification data may include alphanumeric text, e.g., that is printed on the contact user identification card.

The method may also include, after creating a contact user data record, updating the contact user data record with updated contact user information that is different than at least a portion of the contact user information that is stored in the database.

### DESCRIPTION OF THE DRAWING

FIG. 1 schematically illustrates a system and method for efficiently providing contact information in accordance with the present disclosure.

### DETAILED DESCRIPTION

The present disclosure relates to a business card system and a method for facilitating the transfer of contact user information from a contact user (e.g., a buyer or seller of goods and/or services) to a contact information recipient (e.g., another buyer or seller of goods and/or services) in a rapid and efficient manner. Although generally described herein as relating to the purchase/sale of goods and services, it is understood that the contact user information may be provided by the contact user to a third-party (e.g., the contact information recipient) for other reasons that are not directly related to the purchase/sale of goods and/or services, i.e., for the reasons that one would normally pass out a typical business card.

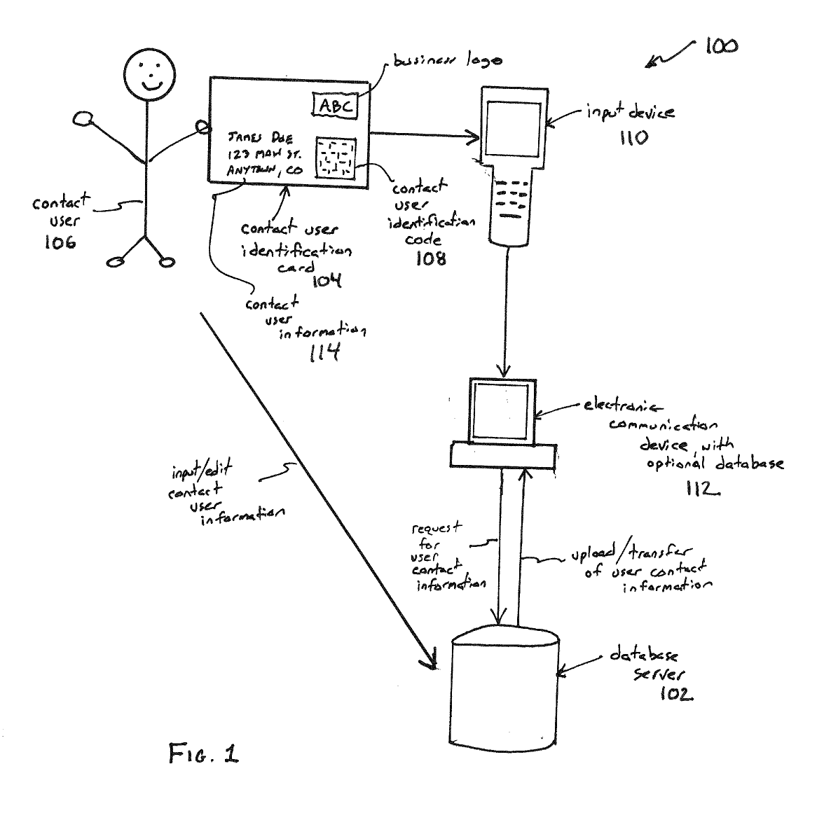

FIG. 1 schematically illustrates a system and method according to an embodiment of this disclosure. Referring to FIG. 1, the business card system 100 may include a database server 102 that is configured to securely store information including contact user information and to provide the contact user information upon receipt of a valid request for the contact user information. The database server may be located at a location that is remote from the users of the system, i.e., in the “cloud,” or may be located in relative close proximity to the users of the system, such as a database server that is located on or near the premises of, e.g., a tradeshow where contact users (e.g., buyers) interact with contact information recipients (e.g., sellers). The database server 102 may comprise memory (e.g., RAM, hard disk drive(s), solid state drive(s) and the like) that is operatively coupled to a processor that is configured (e.g., programmed) to retrieve information from the database stored in the memory and communicate the information (e.g., over a wide-area network or the like) to a requester who has requested the information and provided credentials (e.g., a password and/or a contact user data code) demonstrating permission to obtain the requested information.

The database server 102 includes a database, and the database includes a plurality of contact user data records. Each contact user data record is associated with a specific user of the system 106 (e.g., an individual or a business entity). The contact user data records each include at least two pieces of contact user information. The contact user information may include data that is associated with the contact user, including but not limited to, a contact name (e.g., and individual name and/or a business name), a business or personal title (e.g., “Vice-President”), a contact physical address (e.g., including a P.O. Box number, street name and number, suite number, city, state and/or postal code), a contact telephone number(s), a contact facsimile number and/or one or more contact email addresses. Importantly, in accordance with the system and method disclosed herein, the contact user data records do not include contact user payment data. As used herein, “contact user payment data” is data or other information that can be used to execute a payment (e.g., transfer funds) from the contact user to a third party. Merely by way of example, the contact user payment data that is not accessible from the database may include credit card information (e.g., credit card number, expiration date and/or security code), or may include bank account information (e.g., bank routing number and checking account number). By storing contact user information that does not include contact user payment data, the exchange of contact information such as for the sale of goods and/or services may be facilitated without the risk of compromising the contact user's payment information.

To enable the contact user to provide the contact user information to the contact information recipient, a contact user identification card 104 may be utilized. The contact user identification card may be carried by the contact user 106 and the contact user identification card 104 is associated with the contact user 106 in the database. For example, the contact user identification card 104 may include a contact user identification code that is associated with the contact user data record that is stored in the database. For example, the contact user identification code may be stored in a magnetic strip on the contact user identification card, such as when the contact user identification card is a rigid or semi-rigid plastic card. Alternatively, or in addition to, the user identification code may be readable from a scannable one-dimensional barcode or a scannable two-dimensional barcode, such as a quick response code 108 (“QR Code”) illustrated in FIG. 1. Other means for storing the code are envisioned such as a near field communication (NFC) tag. Further, the user identification code may comprise alphanumeric text that can be read by the contact user, e.g., when ordering goods from a merchant over the telephone, either alone or in combination with the above-described storage means. As with the database server 102, the contact user identification card 104 does not include contact user payment data, e.g., does not include a credit card or debit card number that can be used to facilitate payment for goods or services.

In one particular characterization, the contact user identification card 104 includes both non-human-readable information, e.g., a magnetic strip and/or a scannable barcode, and also includes alphanumeric text representing the identification code that can be read by the contact user. This will advantageously permit the contact user identification card 104 to be electronically scanned or otherwise electronically read, e.g., for a point-of-sale transaction, and will also permit the user identification code to be provided to a merchant at a remote location, such as when ordering by telephone or filling out an order through a fillable form page on the World Wide Web. For example, the alphanumeric text may include a combination of letters and/or numbers (e.g., a single string of letters and/or numbers) that uniquely identifies the contact user. In another characterization, the contact user identification card 104 has the appearance of a typical business card in that it includes at least a portion of the contact information in readable text that is printed (e.g., printed or embossed) on the contact user identification card. See FIG. 1.

Alternatively, or in addition to the foregoing, the contact user identification code may be stored electronically, such as on an electronic device, e.g., a smart phone, smart watch or the like. For example, the smart phone may be programmed via an application to produce the QR code (e.g., displayed on the smart phone screen) that is readable by a merchant at a point-of-sale. Such an application for the electronic device may be provided by the maintainer of the database server that includes the contact user data records, for example.

Utilizing an input device 110, the contact information recipient receives (e.g., reads) the contact user identification code 108 from the contact user identification card 104 or other means provided by the contact user 106. An electronic communication device 112 is operatively associated with the input device 110 to receive the contact user identification code through the input device 110. Depending on the nature of the contact user identification code, the input device 110 may include a magnetic strip reader, a barcode scanner, an alphanumeric keypad, and the like. In one characterization, the input device 110 includes at least two of the foregoing means for receiving the contact user identification code. For example, the input device 110 may include both an alphanumeric keypad and an optical scanner capable of reading a barcode and/or optical character recognition (“OCR”).

The electronic communication device 112 is in operative communication with the database server 102 to transmit the contact user identification code to the database server 102 and to receive the contact user information from the database server 102. For example, the electronic communication device 112 may comprise a point-of-sale terminal having a display screen wherein the point-of-sale terminal receives the contact user information data, from the database server 102 and populates the desired data fields (e.g., name, shipping address) with the information.

Although the input device and electronic communication device are described above and illustrated in FIG. 1 as comprising two separate devices, it will be appreciated that the input device 110 and electronic communication device 112 may be integrated into a single device that is capable of both receiving input regarding the contact user identification code and communicating with the database server 102 to send a request for contact user information and to receive the contact user information. For example, a smart phone including an application for carrying out such instructions may be utilized. In another example, a computer system that integrates the input device (e.g., a keyboard) and communication device (e.g., a wired or wireless internet connection) may be utilized. When the contact user information is received from the database server 102, the contact user information can be populated to corresponding fields, e.g., fields that are displayed on a computer screen, so that an interaction between the parties, such as a sale of goods, can be carried out in a rapid and efficient manner. Payment and other information (e.g., a purchase order number), if needed, can be otherwise input at the point of sale to complete a transaction.

In one characterization, the contact user information that is obtained from the database server 102 by the contact information recipient may be dumped (e.g., deleted) from the contact information recipient's system (e.g., computer) after the information is no longer needed by the contact information recipient, e.g., completion of a transaction. In another characterization, the contact information recipient may have permission (e.g., from the owner of the database server 102) to maintain a personal database of contact user information relating to a plurality of contact users. In this event, the personal database maintained by the contact information recipient may be updated from the database server manually upon a request made by the contact information recipient. Alternatively, or in addition, the personal database may be updated automatically on a periodic basis (e.g., daily) to update the contact information for the contact users in the contact information recipient's personal database by having the updated information “pushed” down from the database server to the personal database. Although described herein as a contact information recipient, it will be appreciated that the contact information recipient may also be a contact user having its own contact user information in the database server 102.

The present disclosure also relates to a method for providing contact user information to a contact information recipient. Broadly characterized, the method may include receiving at a database server, from a contact user, at least two pieces of contact user information selected from a contact name, a contact physical address (e.g., a shipping address), contact telephone number, a contact facsimile number and a contact email address. A contact user data record is created at the database server that includes the contact user information, and the contact user data record is associated with the contact user by establishing a contact user identification code for the contact user. For example, the contact user identification code may be generated for the contact user (e.g., using a random generation algorithm), or the contact user may provide their own contact user identification code.

The contact user identification code will enable the contact user to rapidly and efficiently provide the contact user information to the contact information recipient by merely providing the contact user identification code. Thus, the method can include receiving, from a contact information recipient, a request for at least a portion of the contact user information, where the request includes the contact user identification code. That is, the contact information recipient validates their permission to access the contact user information by providing the contact user identification code. The contact information recipient is then provided (e.g., electronically) with the requested portion of the contact user information. In accordance with the present disclosure, the contact user data record does not include contact user payment data, as is discussed above.

According to one characterization of this method, the contact user is also enabled to update the contact user information that is stored in the database server. See FIG. 1. Thus, after creating a contact user data record, the contact user may update the contact user data record with updated contact user information such as a change of address, phone number and the like. In this manner, the contact user does not have to provide the updated contact information to each contact information recipient individually. Rather, when the contact information recipient accesses the database server, the updated information will be accessible and provided automatically. Alternatively, as is discussed above, the database server may periodically “push” the updated information down to the contact information recipients.

The contact user may be provided with a contact user identification card which may be scannable or tappable, much like a credit card, and the contact user's information populates fields at the transaction point that the contact user has previously provided to the database server. The contact user may keep this card with them just like a credit card or business card. The contact user also can acquire (e.g., purchase from the database server provider) a plurality of disposable (e.g., paper) copies of the same business card with the scannable/readable code to distribute. In one characterization, the contact user identification card, either a more permanent plastic card or a disposable paper card, may also include all or a portion of the contact user information such as a name, address, telephone number and email address, and other indicia such a company logo. See FIG. 1.

While various embodiments of system and method for providing and/or exchanging contact information have been described in detail, it is apparent that modifications and adaptations of those embodiments will occur to those skilled in the art. However, is to be expressly understood that such modifications and adaptations are within the spirit and scope of the present disclosure.

What is claimed is:

1. A business card system, comprising:
a database server comprising a database, the database comprising a plurality of contact user data records, the contact user data records each comprising at least two pieces of contact user information selected from a contact name, a contact physical address, a contact telephone number, a contact facsimile number and a contact email address, where each contact user data record is associated with one of a plurality of system contact users;
a contact user identification card associated with each system contact user, the contact user identification card comprising contact user identification code that is associated with the contact user data record that is stored in the database;
an input device that is configured to receive the contact user identification code from the contact user identification card; and
an electronic communication device that is operatively associated with the input device to receive the contact user identification code through the input device and that is in operative communication with the database server to transmit the contact user identification code to the database server and to receive the at least two pieces of contact user information from the database server;
wherein the contact user data records do not include contact user payment data.

2. The system of claim 1, wherein the contact user data records each comprise at least a contact name, a contact physical address and a contact telephone number.

3. The system of claim 2, wherein the contact name is selected from an individual contact name, an entity contact name or both an individual contact name and an entity contact name.

4. The system of any of claims 2-3, wherein the contact physical address is selected from a billing address, a shipping address or both a billing address and a shipping address.

5. The system of any of claims 2-4, wherein the contact user data records comprise an email address.

6. The system of any of the preceding claims, wherein the user identification data is stored in a magnetic strip on the contact user identification card.

7. The system of claim 6, wherein the input device comprises a magnetic strip reader.

8. The system of any of claims 1-5, wherein the user identification data is stored in a scannable one-dimensional bar code.

9. The system of any of claims 1-5, wherein the user identification data is stored in a scannable two-dimensional bar code.

10. The system of claim 9, wherein the two-dimensional bar code is a Quick Response Code (QR Code).

11. The system of any of claims 8-9, wherein the input device comprises a bar code scanner.

12. The system of any of claims 1-5, wherein the user identification data comprises alphanumeric text.

13. The system of claim 12, wherein the input device comprises an alphanumeric keypad.

14. The system of any of the preceding claims, wherein the electronic communication device is operatively associated with the input device through a wireless connection.

15. The system of any of the preceding claims, wherein the electronic communication device is in operative communication with the database server through a wide area network (WAN).

16. The system of any of the preceding claims, wherein the electronic communication device is in operative communication with the database server through a cellular telephone network.

17. The system of any of the preceding claims, wherein the input device and the electronic communication device comprise a single device.

18. The system of claim 17, wherein the single device is a smartphone.

19. The system of claim 17, wherein the single device is a PC or similar computer having a processor, memory and a display screen.

20. The system of any of the preceding claims, further comprising a contact user input device, where the contact user input device is configured to access the database server and enable the contact user to edit the contact user's data record.

21. The system of any of the preceding claims, wherein the contact user identification card is a plastic card comprising alphanumeric text representing at least a portion of the contact user information.

22. The system of any of claims 1-21, wherein the contact user identification card is a paper card comprising alphanumeric text representing at least a portion of the contact user information.

23. The system of claim 22, wherein the paper contact user identification card comprises a scannable bar code comprising the contact user identification code.

24. A method for providing contact user information to a contact information recipient, comprising:
receiving, from a contact user, at least two pieces of contact user information selected from a contact name, a contact physical address, a contact telephone number, a contact facsimile number and a contact email address;
creating a contact user data record comprising the at least two pieces of contact user information, where the contact user data record is associated with the contact user;
establishing a contact user identification code for the contact user;
receiving, from a contact information recipient, a request for at least a portion of the contact user information, where the request comprises the contact user identification code; and
providing, to the contact information recipient, the requested portion of the contact user information;
wherein the contact user data record does not include contact user payment data.

25. The method of claim 24, wherein the contact user data records each comprise at least a contact name, a contact physical address and a contact telephone number.

26. The method of any of claims 24-25, wherein the contact name is selected from an individual contact name, an entity contact name or both an individual contact name and an entity contact name.

27. The method of any of claims 24-26, wherein the contact physical address is selected from a billing address, a shipping address or both a billing address and a shipping address.

28. The method of any of claims 24-27, wherein the contact user data records comprise an email address.

29. The method of any of claims 24-28, wherein the user identification data is provided by the contact user to the contact information recipient.

30. The method of claim 29, wherein the user identification data is stored in a magnetic strip on a contact user identification card.

31. The method of claim 29, wherein the user identification data is stored in a scannable one-dimensional bar code.

32. The method of claim 29, wherein the user identification data is stored in a scannable two-dimensional bar code.

33. The method of claim 32, wherein the two-dimensional bar code is a Quick Response Code (QR Code).

34. The method of any of claims 24-33, wherein user identification data comprises alphanumeric text.

35. The method of any of claims 24-34, further comprising, after creating a contact user data record, updating the contact user data record with updated contact user information that is different than at least a portion of the contact user information that is stored in the database.
